(19) United States
(12) Patent Application Publication
(10) Pub. No.: US 2003/0033534 A1
(43) Pub. Date: Feb. 13, 2003

(54) System and method for dual key card dual database access control and identification

(76) Inventors: Ricky C Rand, Foxton (GB); Paul Clark, Truro (GB)

Correspondence Address: Eugene C Rzucidlo, Greenberg Traurig, 885 Third Avenue, New York, NY, 10022, US

(21) Appl. No.: 10/148,311

(22) PCT Filed: Nov. 29, 2000
(86) PCT No.: PCT/US00/32598

(51) Int. Cl. H04L 9/00

(52) U.S. Cl. 713/185

(57) ABSTRACT

A system and method for dual key dual database access control and identification system (Dual Key System) and method to maintain security, organization and privacy during electronic transactions. A dual key access card system maintains two separate and distinct database (201, 202), a public file database (202) and a private file database (201), for a given access cardholder. Each access cardholder has a record in each maintained database (201, 202); however, the records can only be integrated through the use of two record identifiers stored on the holder's access card (100). The dual database system allows the data maintained in each database to be kept relatively small, and allows for the anonymous public data to be processed more efficiently without knowing the identity of the person whose information is being maintained. As a result, an affinity-modeling engine can constantly run against the anonymous data while maintaining cardholder security and anonymity.

### CROSS-REFERENCE TO RELATED APPLICATION

This application claims priority from U.S. provisional application No. 60/167,746 filed Nov. 29, 1999, the disclosure of which is incorporated herein by reference.

### FIELD OF THE INVENTION

This invention relates generally to a flexible dual key smart card access control and identification system (Dual Key System) and method to maintain security, organization and privacy during electronic transactions.

### BACKGROUND OF THE INVENTION

Access control and identification (ACI) systems are becoming very popular around the world. Many ACI systems utilize an integrated circuit (IC) or “smart card” to provide security and cardholder identification. Generally, a smart card is a plastic card the size of a credit card that has a signal processing integrated circuit embedded in the plastic. A smart card is inserted into a card reader that couples signals to and from the integrated circuit in the smart card. International Standards Organization (ISO) standard 7816 establishes specifications for an IC card interface.

Smart cards are used to store personal information, ranging from medical information to financial data. In addition, the integrated circuit in a smart card processes data such as security control information as part of an access control protocol. The processor performs various security control functions including entitlement management and generating keys for desrambling and scrambling the data components of a signal.

Current smart card systems maintain data in one particular database identified with the cardholder. In one embodiment of the prior art, the databases may be included on the card. In other embodiments of the prior art, the database may be maintained on a remote file server, where the cardholder may only gain access through the smart card system. In either example, all information in the database regarding a particular cardholder is keyed to that cardholder and unavailable for processing unless “released” by smart card activation.

There are several inherent problems associated with a single database smart card system revealed by the prior art. First there is a security or privacy problem with maintaining all the cardholder's data in one database. Access to the single database by a third party provides the third party with all information concerning the cardholder, including private data that the cardholder may wish to remain anonymous.

Second, since the database can only be accessed upon activation by the smart card, database mining and/or manipulation cannot be performed unless the user has activated the system.

In a media on demand application as described in this invention, providing the subscribing cardholder with preferred programming upon sign-on is of paramount importance. These preferred programming choices might be time dependent. For example, the subscriber may have one programming affinity during Saturday night, and a different programming affinity during Sunday afternoon. Database mining and affinity modeling that can only be performed once the cardholder has activated the system necessarily prevents the media on demand provider from maintaining current preferences and affinity profiles in the cardholder's database.

In addition, single database systems requiring key card enablement to perform database file mining and manipulation may overburden the system during peak use periods when most cardholder subscribers activate the system. This could result in delays bringing media content to subscribers.

Third, single database systems are generally large, and thus costly to maintain and search.

### SUMMARY OF THE INVENTION

The present invention, a dual key smart card identification system (Dual Key System) and method, is directed to a system and method that satisfies the need to provide key holders with privacy and personal security by maintaining select key holder information anonymously in a database.

In addition, the present invention is directed to a system and method that allows a media content provider to anonymously perform affinity modeling for a given smart card holder.

Another feature of the present invention is directed to a system and method that satisfies the need to afford media subscribers the ability to obtain preferred media content independent of the subscribers location.

Another feature of the present invention is directed to a system and method that satisfies the need to use cardholder profile information to restrict media content delivery.

In a preferred embodiment of the present invention, a dual key smart card system maintains two separate and distinct databases, a public file database and a private file database, for a given smart card holder. Each smart card holder has a record in each maintained database; however, the records can only be integrated through the use of two record identifiers stored on the holder's smart card.

The private database maintains such information as the cardholder's name, address, date of birth, account details, subscriber's transaction number, class of media content (movie, audio album, etc.), exact date/time of transaction, transaction amount, and account balances and/or billing information. The public database maintains such information as the cardholder's demographic information, including the subscriber's gender, year of birth (range of years), race, preferences, profile, list of suggested content, the subscriber's transaction number, approximate date/time of transaction, a reference to the content (e.g. name), and a reference to the media previously viewed. For billing purposes, the private database could also contain a transaction number an amount billed, while the public database would contain a detailed description of the transaction related to the transaction number stored in the first database.

The dual database system allows the data maintained in each database to be kept relatively small, and allows for the anonymous public data to be processed more efficiently without knowing the identity of the person whose information is being maintained. As a result, an affinity-modeling engine can constantly run against the anonymous data while maintaining cardholder security and anonymity. This allows the media content provider to: (i) determine the cardholder's preferences and develop an affinity profile prior to cardholder sign-on; (ii) institute time sensitive affinity modeling, such as modifying the cardholder's affinity model based on time of day, week or year; and (iii) modify the cardholder's affinity model to account for new releases of media. Thus, significant data mining and modeling can take place as needed, and enable the system to constantly update profiles to remain current. Accordingly, the affinity-modeling engine does not have to handle peak loads during peak sign-on periods, and may perform affinity modeling during low net user periods.

The dual database system also allows the cardholder's identity and preferences to travel with the cardholder throughout the world. When a cardholder inserts the key card into a card reader, the network processor identifies the unique location of the cardholder. If the network determines that the cardholder is traveling, the affinity model may change the cardholder's preferences accordingly. For example, the cardholder may still receive his preferred television programming, but commercial advertisement may be inserted based on the cardholder's location and/or travel status. Similarly, a cardholder may be able to receive their local telephone calls in the remote location when the network processor identifies the cardholder's present location.

The dual database keycard system may also be used to screen media content from the cardholder by using profile data for restrictions, and selectively delivering programming to a particular cardholder based on these restrictions. The affinity-modeling engine may identify certain characteristics of the cardholder, and compare this data to programming characteristics provided by, for example, the meta-data associated with the media program. The affinity model may then screen the undesirable programming from the cardholder.

The present Dual Key Card system is described in conjunction with particular media on demand and e-commerce transactions. Such systems are described, in part, in a PCT application filed in the U.S. receiving office entitled “A System and Method for Large Scale, Distributed, Personalized Media on Demand”, filed Sep. 20, 2000, which is herein incorporated by reference. However, one skilled in the art can appreciate that this system may be used in many applications where security, anonymous affinity modeling, and global portability of information access for a keycard holder are desired.

### BRIEF DESCRIPTION OF THE DRAWINGS

FIG. 1 shows an illustrative block diagram depicting one general arrangement of the card key user identification and security system according to one embodiment of the present invention.

FIG. 2 shows an illustrative block diagram of the dual database key card system according to one embodiment of the present invention.

FIG. 3 shows an illustrative diagram of the personal database records according to one embodiment of the present invention.

FIG. 4 shows an illustrative diagram of the public database records according to one embodiment of the present invention.

### DETAILED DESCRIPTION OF THE INVENTION

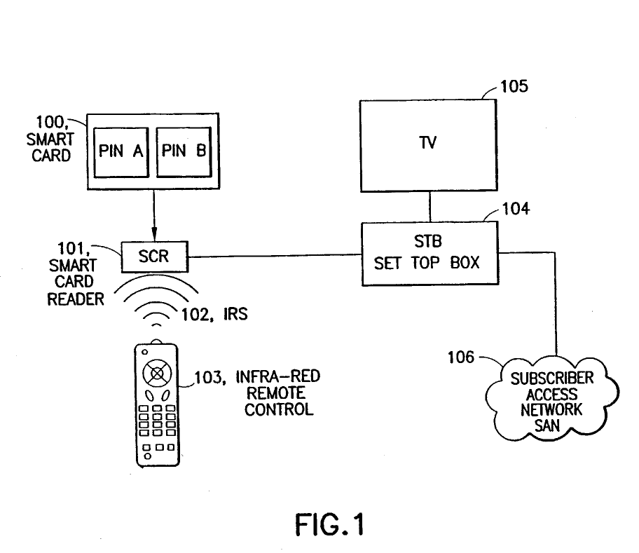

An illustrative block diagram depicting one general arrangement of the dual key smart card user identification and security system and method according to one embodiment of the present invention is shown in FIG. 1. Smart Card (SC) 100 is a dual key card comprising cardholder personal and public identification numbers PIN-A and PIN-B. PIN-A is an identification number that identifies the cardholder's personal database records. Similarly, PIN-B is an identification number that identifies the cardholder's public database records. In a preferred embodiment of the present invention, PIN-A and PIN-B are different numbers. However, PIN-A and PIN-B may not be mathematically related in any way, including by use of well-known public key cryptographic techniques. According, PIN-B cannot be determined using PIN-A and visa-versa.

In one embodiment of the invention, SC 100 may also contain some or all personal data files associated with the cardholder, including the cardholder's name, address, date of birth, and account details, such as cash balances or billing information. In addition, SC 100 may also maintain information for each cardholder (subscriber) transaction, including: a subscriber's transaction number, class of content (i.e. movie, album etc.) the exact time/date, and amount. In a further embodiment of the invention, SC 100 is a modified version of a cash/debit card.

Smart Card Reader (SCR) 101 is a card reader capable of receiving and communicating with SC 100, and communicating with Remote Control Unit (RCU) 103. SCR 101 reads authentication keys from an insertable smart card, in particular SC 100. In a preferred embodiment of the present invention, SCR 101 has infrared control ability, and is capable of communicating with RCU 103 by Infrared Signals (IRS) 102.

Also in a preferred embodiment, SCR 101 has an LCD display; a smart card payment can be performed over a subscriber access network (SAN 106) and the LCD display (not shown) can be used to verify the transaction. Furthermore, SC 100 can make a payment for content to be viewed, or for content viewed on TV 105, over SAN 106 by using SCR 101.

RCU 103 is a remote control, which allows the subscriber to enter key presses to control operations of a set top box (STB 104). In a preferred embodiment of the present invention, RCU 103 is an infrared remote control capable of communicating with SCR 101 by IRS 102. In other embodiments of the invention, RCU 103 may communicate with SCR 101 by radio frequency, or by electrical signals.

The subscriber interface is Set-Top Box (STB) 104. STB 104 may include, for example, a microprocessor, random access memory and non-volatile storage for software, and provides a network interface to Subscriber Access Network (SAN) 106. STB 104 has a television output that displays graphical, textual and audio programming on Television (TV) 105.

In a preferred embodiment of the present invention, SCR 101 is separate from STB 104. In other embodiments of the invention, SCR 101 is integrated within STB 104.

In a further embodiment of the invention, STB 104 also has a mechanism for receiving and interpreting voice commands, either directly or indirectly through RCU 103.

The Subscriber Access Network (SAN) 106 may be one of a number of mechanisms for distribution of high-speed data to residential or business subscribers that is well known in the art, including but not limited to ADSL over traditional telephony copper and QAM/MCNS over traditional community antenna television networks.

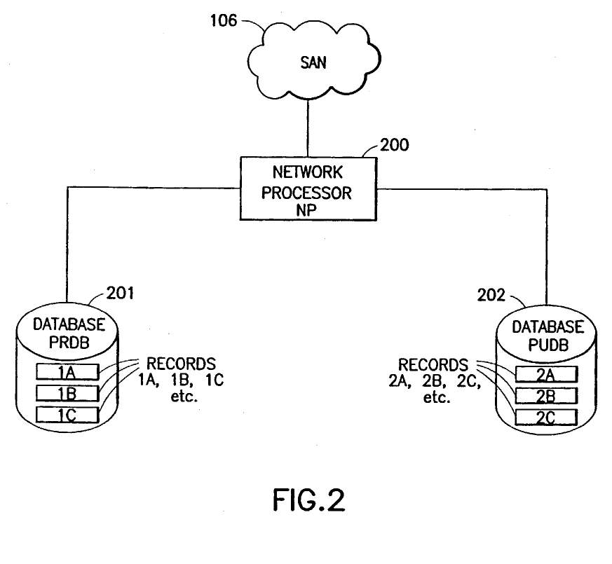

An illustrative system level block diagram depicting one general arrangement of the dual database system and method according to the present invention is shown in FIG. 2. Network Processor (NP) 200 is connected to SAN 106 and interfaces with STB 104. NP 200 is one or more computer systems capable of communicating with Private Database (PRDB) 201 and Public Database (PUDB) 202. In addition NP 200 is capable of performing affinity modeling of subscriber preferences, communicating with similar network processors to achieve global portability for subscribers, and calculating content restriction based on cataloged profile data.

Private Database PRDB 201 and Public Database PUDB 202 are connected to NP 200 through the network. In one embodiment of the invention, PRDB 201 and PUDB 202 are integrated within NP200.

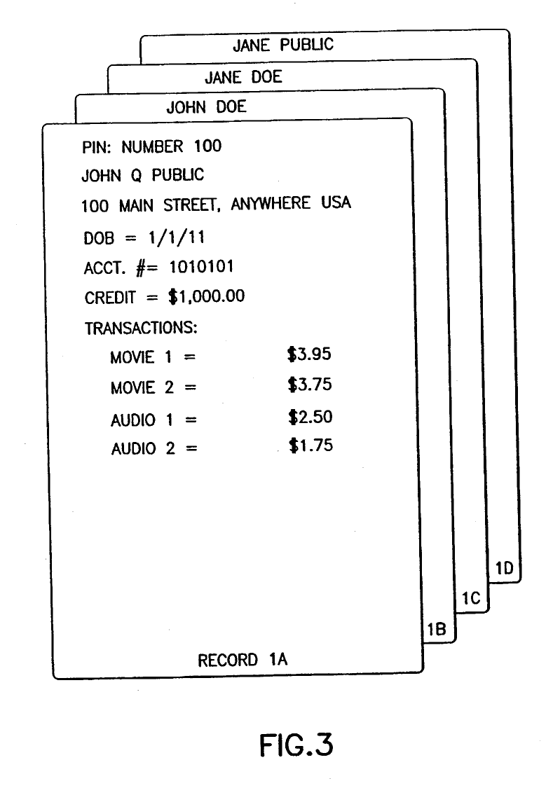

As previously described, PRDB 201 contains private records for various cardholders. By was of example these records may include the cardholder's personal identification number PIN-A, name, address, date of birth, and account details. In a further embodiment of the invention, PRDB 201 also contains the cardholder's account balance. In still a further embodiment of the invention, PRDB 201 contains a generic list of the cardholder's transactions, including the transaction number, class of content, exact date/time, and amount for each transaction. A typical private record for a given cardholder according to one embodiment of the present invention is shown in FIG. 3.

In one embodiment of the invention, database PRDB 201 is kept on smart card SC 100.

Similarly, as previously described, PUDB 202 contains public records for various cardholders. By way of example, these records may include the cardholder's public identification number (PIN-B), gender, year of birth (range), race, preferences, affinity profile, and list of suggested content. In addition, PUDB 202 may also include the cardholder's (subscriber's) transaction number, approximate date/time, and reference to the content (e.g. name), for each transaction. The date/time of each transaction in PUDB 202 need only be approximate. Providing exact date/time of transaction may facilitate a third party attempting to “key” PRDB 201 and PUDB 202 together. Accordingly, in one embodiment of the invention, the date/time on PUDB 202 is generalized into two separate fields—approximate time of day (morning, afternoon, evening) and week number. This allows for time-specific profiling and aging of prior transactions.

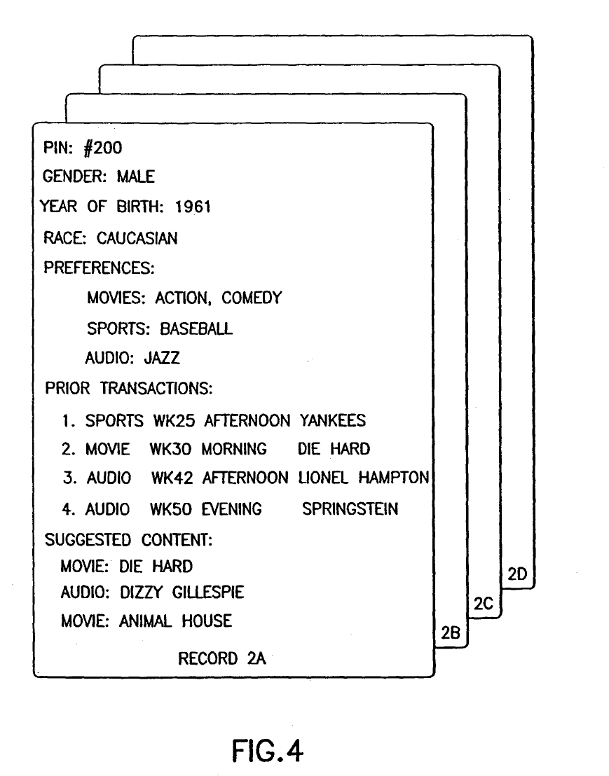

Because PUDB 202 contains anonymous public records, network processor 200 can gain access to and perform affinity modeling on PUDB 202 to update the cardholder's affinity choices anytime. A typical public record for a given cardholder according to one embodiment of the present invention is shown in FIG. 4.

By maintaining the databases PRDB 201 and PUDB 202 separately, the cardholder is provided with a level of security not found in single database applications. Personal data found in PRDB 201 is completely separate from public data kept anonymously in database PUDB 202. Processor 200 cannot “key” these two databases together without the dual identification data (PIN-A and PIN-B) provided on smart card SC 100.

Several security measures have been created to prevent the linking of the two databases (PRDB 201 and PUDB 202) without smart card SC 100. In one embodiment of the invention, the transaction numbers are local to the subscriber, and not globally unique. It is therefore not possible to simply find the records in both databases that contain a particular transaction number and link the two databases together. In addition, the transaction records in private database PRDB 201 are “brown bagged”. That is to say that they only show the date/time and amount of the transaction, and not the full title or any other reference to the content of the media. This allows a hard copy bill to be printed for the subscriber using only PRDB 201, without including any indication of what content was viewed other than, for example the media class description, such as “movie, “album”, etc. Only when smart card SC 100 is in place are both databases available, and hence an on-line statement can provide the subscriber with full details of each transaction.

Another security measure implemented to ensure database PRDB 201 and PUDB 202 remain exclusive, without SC 100, is not maintaining records that include the cardholder's exact date of birth in each database. This is particularly dangerous for small databases where the cardholder's date of birth may be unique. Since affinity modeling may be performed using the subscriber's year of birth, or even a range of years, the exact subscriber date of birth is not included in the public database PUDB 202.

In addition, the relationship, or lack thereof, between the PIN numbers associated with the two databases (PIN-A and PIN-B), provides an added measure of system security. As previously described, PIN-A and PIN-B are not mathematically related in any way; contrary to relationship methods used by known public key cryptographic techniques. A cryptographic method utilizes a two-part key (code) that is made up of public and private components. To encrypt messages, the published public keys of the recipients are used. To decrypt the messages, the recipients use their unpublished private keys known only to them. Accordingly, these two components (public and private keys) are mathematically related in a public key cryptographic system.

It is also desirable to prevent linking the two databases (PRDB 201 and PUDB 202) by intercepting the transmission (so called “snooping the wire”) between STB 104 and NP 200 and hence matching the two keys in the same transaction. In one embodiment of the invention, the transaction from the STB 104 to the NP 200 is encrypted, for example, using a security protocol. One such protocol is Secure Sockets Layer (SSL). SSL is security protocol used on the Internet. When an SSL session is started, the server sends its public key to the browser, which the browser uses to send a randomly generated secret key back to the server in order to have a secret key exchange for that session. In another embodiment of the invention, a separate network processor (NP) for each database may be used (not shown). In this embodiment, the data from each database can be combined by, for example, the STB 104.

Database records, including preferences and selections for the affinity model may be input and or changed in several different ways. In one embodiment of the invention, the cardholder completes a questionnaire on line in real-time upon initial activation. The cardholder may have the opportunity to change this information through a similar on-line process. In another embodiment of the invention, the cardholder completes a questionnaire offline and mails this information to the media content provider. Once received, the media content provider records this information in PRDB 201 and PUDB 202.

Once the data is established in PRDB 201 and PUDB 202 the cardholder's preferences and affinity profile may be changed by processor NP 200 based on the cardholder use history and programming habits. In one embodiment of the present invention, the cardholder's preferences and affinity profile are time sensitive (time of day, week, month or year), and vary based on the of the cardholder's selection.

In a preferred embodiment of the present invention, processor NP 200 performs affinity modeling on database PUDB 202 during off-peak hours and develops an affinity profile for each cardholder. Because all records in PUDB 202 are anonymous public records, processor NP 200 may gain access to PUDB 202 without activation by a cardholder.

A cardholder inserts smart card SC 100 into card reader SCR 101. Card reader SCR 101 can be located anywhere in the world that is connected to SAN 106 through STB 104. See the patent application for “A System and Method for Large-Scale, Distributed, Personalized Media on Demand”, referenced supra, for a description of large-scale media networks.

Card reader SCR 101 reads the identification numbers PIN-A and PIN-B from SC 100 and communicates this information to STB 104. STB 104 in turn provides these identification numbers to processor NP 200 over network SAN 106. Processor NP 200 retrieves the cardholder's personal record from PRDB 201 using PIN-A, and the cardholder's public record from PUDB 202 using PIN-B. The anonymous public records in PUDB 202 may be used to offer the cardholder media choices based on the affinity model.

Once the cardholder selects media content to be delivered, processor NP 200 transmits this media to STB 104 over network SAN 106. STB 104 in turn transmits the media to a user/media interface device such as TV 105. Processor NP 200 also monitors and records the cardholder's activities on databases PRDB 201 and PUDB 202. Private information such as the billing costs associated with the particular selection and account balance or credit are recorded in database PRDB 201. Public information, such as the type of media selected for a given time period (for example a sports program on Sunday afternoon, or comedy movie on Saturday afternoon) are recorded in database PUDB 202. By monitoring and recording the type of media selected for given time periods, processor NP 200 has the ability to perform affinity modeling based on these selections, and modifying and/or changing the cardholder's affinity profile based on the cardholder's programming habits.

Another aspect of the present invention addresses the practice of replacing missing or lost smart cards. If a subscriber loses the SC 101, a new card is recreated which points to the “private side” database PRDB 201. In one embodiment of the invention, the system has a level of indirection between the PIN-A and PIN-B (card keys) and the actual database tables—PUDB 201 and PRDB 202. This system allows for the replacement of lost, misplaced or damaged cards with pre-manufactured cards by making a soft link with the new card key within the database, since the system can search on a subscriber's name, etc. to find the original subscriber's private record. However, since it is deliberately impossible for the system (or anyone) to key these private records with records in the public database, all the profile and preferences stored in the public database PUDB 202 would be lost.

In another embodiment of the invention, a secure slip, similar to the slips received for credit card, are provided to the subscriber. These slips contain a PIN that allows the subscriber to re-enter their public database PIN (PIN-B) on line when they get the replacement card, thus linking the replacement card with PUDB 202.

In still another more preferred embodiment of the invention, the subscriber enters a pass phrase whey they receive the first card SC 101. This pass phrase is used to encrypt, with some well-known secret key system, the public PIN (PIN-B) for storage in the private side database (PRDB 201). On receipt of a replacement card, which is keyed only to the PRDB 201, the subscriber is prompted to re-enter the pass phrase to recover the public PIN (PIN-B). In either case previously described, the smart card itself has to be modified, or preferably as described above; a change is made in an indirection table in the database.

Although the present invention has been described in relation to particular preferred embodiment thereof, many variations and modification and other uses will become apparent to those skilled in the art. It is preferred, therefore, that the present invention be limited not by the specific disclosure herein, but only by the appended claims.

What is claimed is:

1. A flexible dual key dual database access control and identification system for electronic transactions, the system maintaining select key holder information anonymously in a database, the system comprising:
(a) an access card containing a first and a second authentication key, the first and second authentication keys being mathematically unrelated to each other;
(b) a reader capable of interacting with the access card and reading the first and second authentication keys from the access card;
(c) a first database associated with the first authentication key, the first database containing private records of a subscriber;
(d) a second database associated with the second authentication key, the second database containing public records of the subscriber, the first database records and second database records being mutually exclusive and distinct;
(e) a processor for interacting with the first database and second database, the processor being operatively connected to the reader; and
(f) a network operatively connecting the processor and the first and second databases.

2. The system of claim 1 wherein the access card is a smart card.

3. The system of claim 2 wherein the smart card is capable of recording the credit and/or debit associated with the electronic transaction.

4. The system of claim 1 wherein the reader is a smart card reader.

5. The system of claim 1 wherein the first database resides on the access card.

6. The system of claim 1 wherein the second database is remote from the first database.

7. The system of claim 1 wherein the network is a wide area network.

8. The system of claim 1 wherein the network is a local area network.

9. A method for providing secure access and privacy during electronic transactions using a dual database dual key system, the method comprising the steps of:
(a) reading a first and a second authentication key from an access card, the first and second authentication keys being mathematically unrelated to each other;
(b) accessing a subscriber's private records from a first database using the first authentication key;
(c) accessing the subscriber's public records from a second database using the second authentication key the private records and public records being mutually exclusive and distinct; and
(d) integrating the private records and the public records.

10. A method for providing privacy during electronic transactions using a dual database dual key system, the method comprising the steps of:
(a) monitoring a subscriber's electronic transaction;
(b) recording private information associated with the electronic transaction in a first database, the first database being associated with a first authentication key; and
(c) recording public information associated with the electronic transaction in a second database, the second database being associated with a second authentication key, the first and second authentication keys being mathematically unrelated and being stored on an access card.

11. A method for providing preferences to a subscriber for delivery of media content, the method comprising the steps of:
(a) performing affinity modeling on records in a first database associated with the subscriber, the first database being related with a first authentication key;
(b) determining the preferences for the subscriber based on the affinity modeling;
(c) reading the first and a second authentication key from an access card, the first and second authentication keys being mathematically unrelated to each other;
(d) accessing records from a second database associated with the subscriber using the second authentication key, the second authentication key being related to the second database; and
(e) providing the preferences for the delivery of media content to the subscriber.

12. The method of claim 11 further comprising the steps of:
(a) determining the location of the subscriber; and
(b) providing media content to the subscriber based on the location of the subscriber.
